(19) United States
(12) Patent Application Publication
(10) Pub. No.: US 2005/0226398 A1
(43) Pub. Date: Oct. 13, 2005

(54) Closed Captioned Telephone and Computer System

(76) Inventor: Mark C. Bojeun, Centerville, VA (US)

Correspondence Address: GREENBERG & LIEBERMAN, 314 PHILADELPHIA AVE., TAKOMA PARK, MD, 20912, US

(21) Appl. No.: 10/907,668

(22) Filed: Apr. 11, 2005

Related U.S. Application Data
(60) Provisional application No. 60/521,361, filed on Apr. 9, 2004.

(51) Int. Cl. H04M 11/00

(52) U.S. Cl. 379/93.15; 379/52

(57) ABSTRACT

A Closed Caption Telephony Portal (CCTP) computer system that provides real-time online telephony services that include utilizing speech recognition technology to extend telephone communication through closed captioning services to all incoming and outgoing phone calls. Phone calls are call forwarded to the CCTP system using services provided by a telephone carrier. The CCTP system is completely transportable and can be utilized on any computer system, Internet connection, and standard Internet Browser. Employing an HTML/Java based desktop interface, the CCTP system enables users to make and receive telephone calls, receive closed captioning of conversations, provide voice dialing and voice driven telephone functionality. Additional features allow call hold, call waiting, caller id, and conference calling. To use the CCTP system a user logs in with his or her username and password and this process will immediately set up a Virtual Private Network (VPN) between the client computer and the server.

### PRIORITY CLAIM

Priority is hereby claimed to provisional patent application No. 60/521,361 filed Apr. 9, 2004.

### FIELD OF INVENTION

The present invention relates to a software application providing hearing-impaired individuals with telephone communication through the use of speech recognition. More particularly, the present invention relates to a closed caption telephony portal (CCTP) application that provides users the ability to login to a web site that will present real-time text translation of their day to day telephone conversations directly on their computer, PDA, or Internet enabled phone screen, utilize conventional telephone equipment, and benefit from the system at any location.

### BACKGROUND OF THE INVENTION

In the United States there are 25 million people defined as hearing impaired. Of these 25 million, only 5 million currently use hearing aids. Even though 20 million people currently are estimated to have hearing impairment, for a number of reasons they do not choose to utilize hardware such as hearing aids. As a result, these individuals struggle daily with communication over telephone equipment.

Hearing loss is the number one disability in the world. Many of these individuals are businessmen and women for whom the telephone is a necessary tool for their profession. The Department of Health and Vital Statistics estimates that 29% of the hearing-impaired individuals in this country are in managerial or professional roles. An additional 34% are in sales, service or administrative functions. Furthermore, 15 of every 1000 students under the age of 18 are hearing-impaired.

The major issues facing hearing-impaired individuals in telephone communication is that they are consistently missing 10-40% of the conversation. This requires a hearing impaired individual either to ask the other person to restate the conversation or try to fill in the blanks on his or her own. Hearing impaired individuals often can garner greater understanding through non-verbal communication and will understand a larger portion of the conversation in face-to-face communication. Therefore, the telephone without the ability to transmit non-verbal communication can be a hindrance to hearing-impaired communication. Many times, an individual will avoid using the telephone because of these difficulties, with attendant reduced enjoyment of life.

Solutions to this problem have been primarily focused on increasing the volume of the telephone with related assistive devices, TTD-TTY facilities and voice relay systems:

Amplified telephones can be helpful but address the problem in a very limited, rudimentary fashion. When employed in public, they are rendered even less useful due to background ambient noise, as any hearing impaired person can attest who has ever attempted to use an amplified pay phone in a busy airport with constant flight announcements on the loud speaker.

TTY (an acronym for Teletype and also known as TTD Text Device for the Deaf) is a telecommunication device for the deaf and hearing-impaired who cannot communicate effectively on the telephone. A device similar to a typewriter prints the conversations on screen or paper so that the hearing impaired individual may read it. A TTY/TTD must connect with another TTY/TTD device in order to function. Unlike the present invention, if one participant does not have a TTY/TTD device, the use of a relay service is a required. Moreover, unlike the present invention, TTY-TTD devices may be used only at the location of the device, which is not readily portable and customarily remains at a fixed location.

A voice relay service comprises an operator who has a TTY-TTD device to translate between two participants. With a third party listening in on a conversation, utilizing a relay service eliminates a sense of privacy for the user. It is a cumbersome, inconvenient means of having a telephone conversation. As a result, it generally is reserved for important telephone calls and rarely used for the many personal and routine calls in every day life enjoyed by individuals with normal hearing.

To enable hearing-impaired individuals with the ability to watch television programs, closed captioning is often employed. Closed captioning systems take spoken dialogue from television programs and translate the dialogue into superimposed text on the video image. Closed captioning appears on television screens like film subtitles. A receiving computer, containing typed dialogue from a television program, transmits the caption data via a modem to an encoder. The encoder inserts the caption data into a blank gap in the video signal, and transmits this combination to the viewer's home receivers. The receivers decode and display the image and text. Thus, an individual with a hearing impairment may still be able to follow the television program and understand what is being said in the program despite the fact they may not be able to hear the spoken words.

U.S. Pat. No. 5,508,754 issued to Orphan on Apr. 16, 1996 shows a system for encoding and displaying captions for television programs in real-time, yet unlike the present invention this device does not operate with a telephone service and is primarily designed for television. Thus, this device is not capable of aiding someone in telephone communication.

A speech recognition engine translates a digital audio input signal into a text format. Speech recognition is also known as automatic speech recognition (ASR). In brief, speech recognition engines conduct analysis on digital audio input signals. Such analysis comprises of distinguishing the frequency range of the incoming signal, identifying phonemes in the distinguished input signal, and identifying words and groups of words.

U.S. Pat. No. 5,384,892 issued to Robert D. Strong on Jan. 24, 1995 shows a language model and method of speech recognition that concludes the sequences of words that may be recognized and the selection of an appropriate response based on words recognized. Yet unlike the present invention, this device has no connection with a telephone, and thus provides no service to the hearing impaired in the aspect of improved telephone communication.

U.S. Pat. No. 6,311,182 issued to Sean C. Colbath on Oct. 30, 2001, U.S. Pat. No. 6,101,473 issued to Brian L. Scott on Aug. 8, 2000, U.S. Pat. No. 5,819,220 issued to Ramesh Sarukkai on Oct. 6, 1998 show speech recognition systems, yet unlike the present invention, these devices are used to access and navigate the Internet.

Hearing-impaired individuals come from all walks of life and all financial and educational levels. Any application that is developed to assist them in telephone communication must be both sophisticated in its functionality as well as flexible to specific user needs. Thus there is a need for a system that provides captioning as a tool to fill in the missing pieces of a conversation; A system that includes a consistent interface in both a home and work environment, a user friendly interface that provides complex services to users, yet does not require any additional hardware, expensive services, or additional privacy issues involving operators on phone calls.

### SUMMARY OF INVENTION

The CCTP application is to be a revolutionary approach to telephone communication for the hearing-impaired. This software entails a client application stabling a Virtual Private Network (VPN) to a server application. Voice and text are transmitted simultaneously to the user from a server farm. The server farm utilizes a server-based application that enhances the current capabilities of telephony servers and speech recognition servers. The software will be delivered to users through an Internet website providing a subscription service to the user. This product will provide real time speech recognition results in a caption window, in order to provide hearing impaired individuals with a text transcript of their live telephone call. The CCTP application of the present invention will provide completely confidential, automated captioning to the user. No operators will be online and conversations will only be between the two parties. Additional security will prevent any unauthorized users from intercepting or eavesdropping on any conversations.

The CCTP will provide users with closed captioning for all telephone communication through the use of a specialized application utilizing Speech Recognition and Telephony servers, delivered through an Internet browser on any Internet enabled computer. The service will be available for all incoming and outgoing phone calls and will be able to handle 2-party or conference call communication. The CCTP system enables users to go to a website where they can sign up for service. Users will then download the client application and they will be given a set of instructions to configure their phone for use. These instructions are similar to the keystrokes necessary to set up a phone for call forwarding. Once the phone has been configured users are ready to start using the service.

Once the phone has been configured, all incoming and outgoing calls will route though the present invention's speech servers. The routing of the telephone calls will not cause any disturbance to the quality of service but the speech servers will interpret all audio streams, in order to provide real time closed captioning. The speech servers will be configured with two additional features not part of current technology. First, the speech servers will provide automated noise canceling, eliminating sounds outside the range of human hearing. These sounds can be found in nature and can be created from analog telephones. The underlying tones will be identified and will be eliminated as speech is not within this decibel range. The clean up of the sound will affect only the audio transmission to the speech server and will not affect the overall sound quality for the user. Second, the system will provide an automated profile matching system that will optimize the performance of the recognition engine.

Most speech recognition engines provide a profile for users to be able to train the computer for their voice. Each individual's voice is unique based on the vocal pattern of words and sounds. The CCT application will mesh vocal patterns and evaluate profile recognition confidence ratings to locate a more viable and consistent profile. A database will be used to store the vocal patterns of profiles and will have identifying factors indexed to allow for rapid retrieval of patterns closely matching the caller's patter. The system will leverage all profiles stored on the server and will identify profiles based on the vocal pattern of each. Profiles that more closely match the caller's vocal pattern will be instantiated in the background with simultaneous processing on both the primary profile as well as the identified matching profiles. The system will analyze the current and alternate profiles and the resulting recognition confidence factor evaluated. Through this process the speech recognition engine will dynamically adjust the caller profile until the highest recognition confidence factor is reached. This process will be conducted asynchronously and will be transparent to the caller and the user of the application. Once a valid profile has been located the system will replace the default profile with the more closely matched profile providing better recognition results.

In vocal pattern identification an audio spectrograph is used on a 0 to 4000 or 8000 Hz range to chart the audio frequency, duration, and pattern of the speaker. These points can be then utilized to determine the speaker's identity. The CCTP will utilize a similar technology but will look to identify less than the 20 similarities required for positive identification. Instead the CCTP will look for an increasing amount of correlating factors to determine similar spoken patterns. Biometric identification would require the examiner would study bandwidth, trajectory of vowel formats, distribution of formant energy, nasal resonance, mean frequencies, vertical striations and the relations of all features present as affected during articulary changes and any acoustical patterns. The CCTP will pattern each profile based on frequency ranges, mean frequencies, vertical striations, and distribution of formant energy. These individual factors will be collated and stored as indexed features of the profile database. As in voice identification, the longer the vocal pattern the more effective the pattern matching, the CCTP will run a continuous evaluation of the caller in an attempt to gain a greater confidence rating on the recognition results.

Contrary to the voice identification model, profile matching will not require callers to speak a set phrase over and over. Instead common words will be identified and matched to patterns. As the recognition engine is capable of returning the valid word from the spoken voice these “snippets” will be matched against the database to find other similar patterns. Providing a “Natural Voice Identification” system, the CCTP will not look to match names or identities, instead the CCTP is focused on matching the patterns to achieve a more accurate result for voice recognition.

Background noise can cause greater problems with speech recognition than any other factor. With the elimination of background noise, recognition rates dramatically increase in every circumstance. Therefore, the CCT application focuses on the elimination of the white noise common on analog phone systems and digital cellular systems to increase the quality of the audio quality prior to the recognition engine evaluating the incoming audio stream. The CCTP will work to minimize the Signal to Noise ratio by decreasing ambient noise factors. The effectiveness of this will be measured in an improvement of 10 to 25 decibels. Decibels (dB) are a measure of the speech signal and the noise signal power. A dB improvement of 20 for example means that the Sound Noise Ration (SNR) of the extracted signal and the SNR of the original signal has a difference of 20 dB. Decibels are measured on a log scale referenced to base 10. ex. SNR=10 log (speech power/noise power). The original signal has a SNR of 0 dB, if speech power (SP) equals the noise power (NP) of the original signal. If the SP is 100 times the NP in the extracted signal, the extracted signal has an SNR of 20 dB, because 10×log(100)=20. Since 20−0=0, the SNR improvement between the extracted signal and the original signal is 20 dB.

Users can log into their account from any Internet enabled computer. Once they have logged on to the site, a VPN is established between the user and the present invention's servers. From then on users will be able to view the caller's side of the conversation real time on their monitor.

Through usage of the present invention, phone calls will continue to operate 100% standard and the service will not require any additional hardware. The present invention is available for the user for all phone calls. It is activated when a user makes or receives a call. The CCTP system can be turned off from either the phone or from the website. If the system is left on and the user is logged into the website the users conversations will continue to be transcribed.

Through the use of the centralized speech recognition servers all applications developed to interface with the CCT and the CCC systems will provide a fuzzy logic, multi-modal interface. Fuzzy logic is a structured, model-free estimator that approximates a function through linguistic input/output association. This interface will allow users to take advantage of basic and advance functionality without learning a complex set of functional codes. All interaction with the system will be voice enabled as well as keystroke and mouse accessible. Users will be offered an initial set of pre-defined commands to interact with the system. These commands will be fuzzy logic enabled and will be capable of parsing out statement such as “would you please”, “please” and “I would like to” and remove them from the command structure to enable users to interact with the system in as realistic a manner as possible. This fuzzy logic module will be enhanced over time and will provide added benefits to the users.

Initially users will be given a choice in naming their system (i.e. “computer”, “telephone”) or by using predefined commands (“Wake”, “Computer”, “PC Call”) to initiate contact with the computer. If there is no keyword given, the computer would constantly interpret commands by the users incorrectly. Users will be able to modify the command structure to work in their own environment.

### BRIEF DESCRIPTION OF THE FIGURES

FIG. 1 is a flow chart showing the process of using the present invention.

FIG. 2 is a flow chart showing the various components of the present invention.

FIG. 3 is a flow chart showing the profile matching of the present invention.

### DETAILED DESCRIPTION

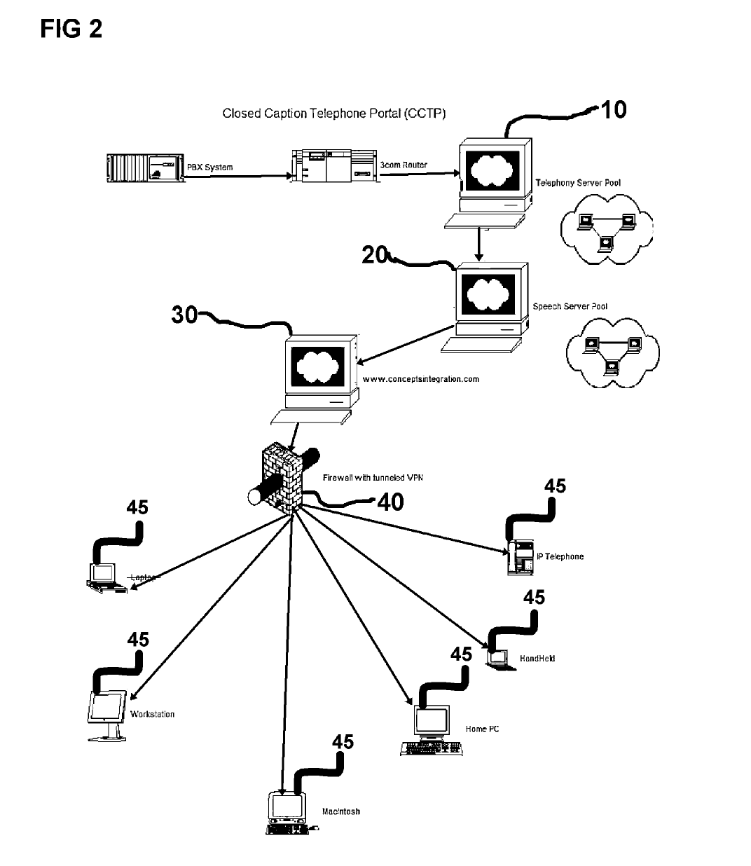

The CCTP system, as shown in FIG. 2, will be a state of the art application and will have a downloadable desktop interface to allow users to make and receive telephone calls, receive real-time closed captioning of conversations, provide voice dialing and voice driven telephone functionality. Additional features will allow call hold, call waiting, caller id and conference calling. The Internet based application will follow industry standards and will work from any Internet enabled device. Users will be able to install the client application and run the system from home, work, cell phone, PDA, or a laptop. Physical location will not matter, as the client application will provide the VPN with the current IP address of the client machine.

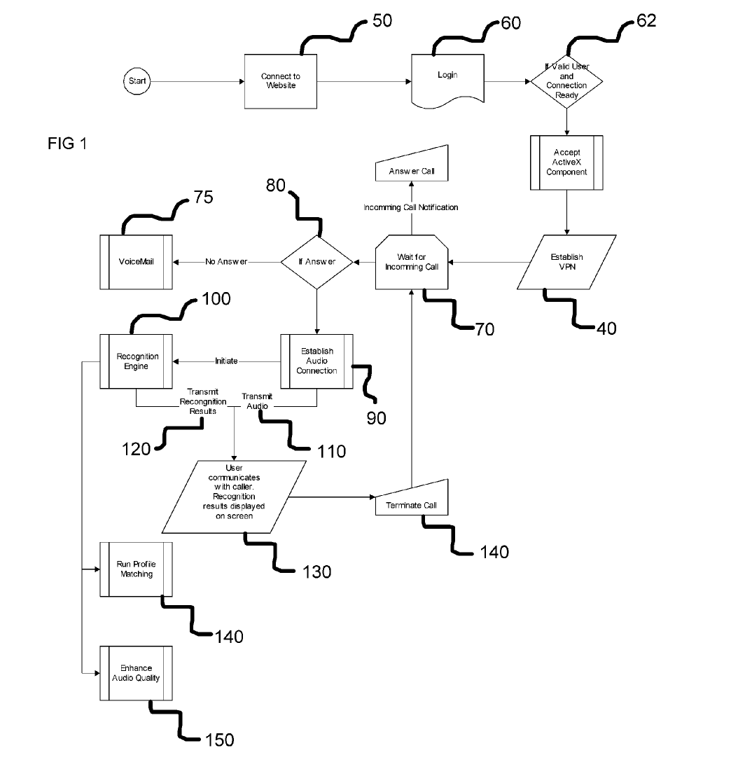

As shown in FIGS. 1 and 2, users will be able to login (60) with their username and password and will immediately set up a Virtual Private Network (VPN) (40) between the client device (45) and the web server (30). Users will conventionally call-forward their phone to the present invention using conventional services provided by the telephone carrier. Users will have the option of purchasing a conventional VoIP converter box allowing the use of normal 4 wire telephones to be used in all communication. The only required service for users is to ensure they have conventional call forwarding. Call forwarding is a service provided by every major telephone and cellular service. Charges for call forwarding are generally a nominal fee but will be dependent on the individual company.

The present invention will include a website at web server (30) that will provide all members with marketing and configuration options. The website will be designed as a virtual storefront and will provide users with detailed information at their fingertips. The intention is to provide enough useful on-line information that support telephone calls and emails are minimized. Additionally users will be able to maintain their own account information and to modify payment method, cancel/start service, and maintain billing address information. All this will be done via conventional means.

The present invention consists of a Telephony PBX modem (10), Speech Server (20) and Web Server (30). The interaction of these three integral systems is the core technology of the application. These three main systems will be configured to interact in a seamless manner that provides the functionality necessary to the system. Additional applications of the present invention may provide client VPN connections, monitor and notify users of incoming calls, pass the recognition text to the users Java applet and allow users to initiate phone calls. Additional speech recognition is provided to users to enhance features and functionality of the application. This functionality enhances the application to a multi-modal client and will utilize a command based SALT interface. The logic behind this interaction will be developed to follow fuzzy logic in an attempt to minimize training and support issues.

The present invention's main functionality is to provide closed captioning of all incoming and outgoing calls. Only the incoming transmission is captioned. This provides the user with the cleanest possible interface. The interface is kept to a sheer minimum to avoid distraction. At the top of the recognition the initial recognition results will be displayed. As a phrase or sentence has been confirmed as recognized it moves into the main text area. Each added line is added at the top of the text box. This keeps the users' eyes focused on both the estimated recognition results as well as the confirmed recognition.

Through the use of the speech recognition servers all applications developed to interface with systems employed by the present invention provide a fuzzy logic, multi-modal interface. Fuzzy logic is a structured, model-free estimator that approximates a function through linguistic input/output association. This interface allows users to take advantage of basic and advance functionality without learning a complex set of functional codes.

Utilizing a custom formula that defines the functional value of a spoken sentence or phrase employs fuzzy logic. Words are categorized as nouns, verbs, adjectives, adverbs and pronouns. With this categorization in place the present invention sorts through pleasantries, descriptors, placeholders and filler words found in common language to determine the functional intent of the statement. For example, “Would you please call George?” is evaluated to: “Call George;” Which in turn executes the lookup functionality and ultimately is evaluated to: X=call (704-555-1111, “George”). Although this functionality provides a certain amount of complexity in the coding it provides truly enhanced simplistic functionality to the user.

Multi-modal is a functional interface that provides interaction through text, graphics, voice, keyboard and other input devices. None of the input devices are deemed primary and input comes from a logical derivation of the sum of all inputs. Although the fuzzy logic interface allows users to interact with the system on a purely verbal basis, it is in itself not enough to provide ultimate interaction. Users must also be given the ability to interact with the system via keyboard, mouse, trackball, or touch screen and may at any one time utilize a multiple number of interfaces. In this case “Please call” would be followed (or preceded) by a mouse click on a name. This would evaluate to: Call (lb_names.selecteditem, lb_names.selecteditem.value). From this example, we can see that a number of interfaces, and interactions by the users are possible while still issuing the same command.

A Fuzzy-Logic Multi-modal application is employed by the present invention to ease the use and expand on the functionality of the application for the user. In an alternative embodiment, the present invention provides additional functionality through fuzzy logic enabled vocal commands. This multi-modal interface enables users to interact with their computer through normal conversation patterns and does not require training and manuals to become adept with the software. The interface permits users to place calls, set up preferences, save and print historical conversations and to instantiate services when desired.

The present invention provides users with Caller-ID and will store the Caller-ID data along with the transcription of the phone call. Incoming calls offer both visual and audio notification and can be customized to the users preference.

The system permits users to maintain a phone book along with historical transcripts of the telephone calls and through the use of a fuzzy logic based multi-modal interface enables users to interact and initiate telephone calls through voice, mouse or keyboard commands. The voice recognition commands allow users to interface with the system in conversational mode and does not require users to learn specific command structures.

The present invention maintains the highest standards for maintaining the security of the users' information. All authentications done are through Kerbos security and maintain the highest protection available. In addition, since there is no trace ability in the conversations, there is no way to directly attribute the words with any individuals. Transcripts of conversations can be set up to immediately delete, or to archive, based on the user's preferences.

In an alternative embodiment, the present invention's users have the ability to use as a client device (45) an Internet enabled laptop or PDA and a microphone to obtain closed captioning for real time face-to-face conversations. The present invention permits the user to place a microphone at the center of a table and to have direct closed captioning of meetings, one on one conversations and conferences. By establishing a VPN with the speech servers you can have real time speech recognition results for your own uses. Individual speakers are distinguished by vocal patterns. A meeting starts with all individuals involved identifying him or her, the present invention matches the name to the vocal pattern and each user is identified by name. Systems can easily be set up in an office or meeting room so that all conversations can be captioned for the hearing impaired attendees. This alternative embodiment allows the user to generate meeting minutes in seconds accurately or just use it to ensure the user's accuracy in understanding the conversation.

As shown in FIG. 1, the process that a typical user would do to initiate the CCTP system begins by starting the client application and connecting to the Website (50) via the Internet, to log in (60), and if the user is a valid user (62), the connection is made to the CCTP system. At the time of connection the VPN (40) is established. The user is now ready to receive incoming calls (70). Once a call comes in, the user is notified and can answer the call (80). If the user does not answer the call, the call will go to voice mail (75). If the call is answered, the CCTP will establish audio connection (90) and the recognition engine (100) will transmit the audio (110) and transmit recognition results (120) and the user is able to communicate with the caller (130). Once the call ends (140), the CCTP system is again available for the next incoming call. Additionally, the system could be modified slightly to allow for the input from multiple microphones. Microphones could be labeled dynamically with speaker names and the audio stream transmitted to the server application. Functionality such as this would provide the ability for hearing impaired individuals to receive captioning from meetings and conferences. Because multiple speakers would be involved each microphone would be identified as an individual speaker. In the text transmission speaker names would preface the text attributing the words directly to the speaker.

Advantages to this would be the enabling captioning court conversations to ensure that hearing impaired individuals are granted a fair trial, ability to perform their jobs as attorneys or judges, or to be jury members.

Conference calls are also a viable alternative strategy to this product. Once a phone call has been digitized and packaged for transmission over IP the ability to run the transmission through the optimized speech recognition engine would enable the user to caption conference calls, and voice mails. This provides additional functionality to the hearing impaired.

Other functionality that would be beneficial would be the use by non-impaired individuals to caption a meeting and receive real-time meeting minutes. Each individual would be identified and text would be attributed to the individual.

Voice pattern matching could further be used to allow individuals on a conference call without individual microphones to speak their name and a small phrase. The system can then be used as a voice pattern analysis application and identify the speaker with their individualized voice pattern so that all text can be attributed to the individual speaker.

The CCT application is designed for the purposes of providing captioning to hearing impaired individuals through speech recognition and Voice over IP technology. However, additional functionality can and will be available directly from this application. With the increase in processor performance found in PDA's and cellular phones the CCT would be able to provide users with the ability to caption any conversation they are holding. The system would enable the users to transmit an audio stream and receive a text transcription of the audio stream. This functionality would be tremendously beneficial to hearing impaired individuals as part of their daily and business related lives.

As aforementioned, the recognition engine (100) of the present invention will transmit the audio (110) and transmit recognition results (120) and the user is able to communicate with the caller (130). Audio quality enhancement (150) is part of the recognition engine (100). Audio quality enhancement (150) is any conventional system that can perform a “clean up” before the transmit recognition results (120) occurs. Whereas a normal speech recognition engine would establish audio connection (90) with a conventional high quality microphone and zero background noise, the present invention will most likely not be configured with a conventional high quality microphone and background noise is expected. Thus, audio quality enhancement (150) provides automated noise canceling eliminating sounds outside the range of human hearing. As aforementioned, these sounds can be found in nature and can be created from analog telephones. The underlying tones will be identified and will be eliminated as speech is not within this decibel range. The clean up of the sound will affect only the audio transmission to the speech server (20) and will not affect the overall sound quality for the user.

Profile matching (140) is part of the system (100). Profile matching can be accomplished with any speech recognition engine. Profile matching (140) is any conventional system that aligns the voice pattern of the caller with other stored profiles to increase recognition rates. As aforementioned, it is preferred that a database will be used to store the vocal patterns of profiles and will have identifying factors indexed to allow for rapid retrieval of patterns closely matching the caller's pattern. The system will leverage all profiles stored on the server and will identify profiles based on the vocal pattern of each. Profiles that more closely match the caller's vocal pattern will be instantiated in the background with simultaneous processing on both the primary profile as well as the identified matching profiles. The system will analyze the current and alternate profiles and the resulting recognition confidence factor evaluated. Through this process the system will dynamically adjust the caller profile until the highest recognition confidence factor is reached. This process will be conducted asynchronously and will be transparent to the caller and the user of the application. Once a valid profile has been located the system will replace the default profile with the more closely matched profile providing better recognition results.

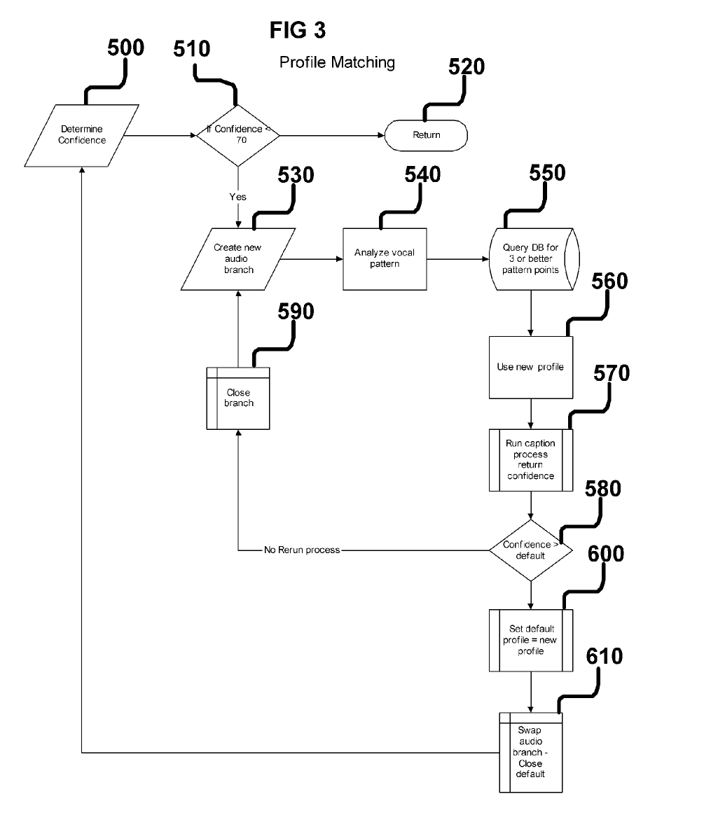

As shown in FIG. 3, profile matching (140) is diagrammed per the aforementioned description to show how it will preferably operate. The first step is to Determine Confidence (500) and If Confidence<70% (510) is no, then profile matching (140) will Return (520) to do more sampling of an audio stream. If Confidence<70% (510) is yes, then the profile matching (140) moves to do the following: Create new audio branch (530), Analyze vocal pattern (540), Query Database for 3 or better pattern points (550), Use new profile (560), and Run caption process return confidence (570). If Confidence>default (580) is no, then the process is rerun and Close branch (590) closes the path begun from Create new audio branch (530). If Confidence>default (580) is yes, then the process continues as follows: Set default profile=new profile (600), Swap audio branch−close default (610) occurs, and then the process returns to Determine Confidence (500) to so that the speech recognition engine can dynamically adjust the caller profile until the highest recognition confidence factor is reached.

The embodiments offered are but a few possible embodiments of the present invention for illustrative purposes herein, other embodiments, expansions and enhancement are obvious to those with an ordinary skill in the art, and are within the scope of the following claims.

1. A device for allowing voice and text communication via a telephone line, comprising:
a recognition engine for converting the voice from the phone line to text;
a means for transmitting the text from said recognition engine to a remote site; and
a means for transmitting the voice from the phone line to a remote site.

2. The device of claim 1, wherein said recognition engine has profile matching technology.

3. The device of claim 1, wherein said recognition engine has enhanced audio quality technology.

4. The device of claim 2, wherein said profile matching technology aligns a voice pattern of a caller with other stored profiles to increase recognition rates.

5. The device of claim 3, wherein said enhanced audio quality technology provides automated noise canceling eliminating sounds outside the range of human hearing.

6. The device of claim 1, wherein said means for transmitting text from said recognition engine to a remote site is accomplished via the internet.

7. The device of claim 1, wherein said means for transmitting text from said recognition engine to a remote site is a telephony server pool coupled to a speech server pool.

8. The device of claim 1, further comprising a means for receiving the text from said recognition engine.

9. The device of claim 8, wherein said means for receiving the text from said recognition engine is a personal digital assistant.

10. The device of claim 8, wherein said means for receiving the text from said recognition engine is a computer.

11. The device of claim 8, wherein said means for receiving the text from said recognition engine is an internet protocol telephone.

12. The device of claim 2, wherein said recognition engine has enhanced audio quality technology.

13. The device of claim 12, wherein said recognition engine first removes sounds outside the human range of hearing to improve intelligibility of speech on a phone line, and then compares a voice pattern of a caller with other stored profiles to increase recognition rates.

14. The device of claim 1, further comprising a means for converting the voice analog signal to a digital signal prior to processing by said recognition engine.
